(19) United States
(12) Patent Application Publication
(10) Pub. No.: US 2024/0263874 A1
(43) Pub. Date: Aug. 8, 2024

(54) SYSTEMS AND PROCESSES FOR DRYING GRANULAR MATERIALS

(71) Applicant: Novatec, Inc., Baltimore, MD (US)

(72) Inventors: Conrad BESSEMER, Millersville, MD (US); Mark HAYNIE, Pasadena, MD (US); Diego Ruben BARRETTINO, Lugano (CH); Sean P. HEALY, Aiken, SC (US); Ryan ISMIRLIAN, Glen Burnie, MD (US); Frederick W. EICHHORN, II, Finksburg, MD (US); Gregory Michael Washburn, Bridgeville, MD (US)

(73) Assignee: Novatec, Inc., Baltimore, MD (US)

(21) Appl. No.: 18/467,810

(22) Filed: Sep. 15, 2023

Related U.S. Application Data
(60) Provisional application No. 63/406,836, filed on Sep. 15, 2022.

(51) Int. Cl. F26B 3/16; B29B 13/06; F26B 25/22

(52) U.S. Cl. CPC F26B 3/16; B29B 13/065; F26B 25/22; F26B 2200/06; F26B 2200/08

(57) ABSTRACT

Systems for drying granular materials, such as resin granulates, powdered materials, and agricultural grains, can include a storage vessel for holding the granular material; a drying hopper having a body defining an interior volume configured to receive the granular material; a diffuser configured to direct process air into the interior volume; a vacuum source for transferring the granular material from the storage vessel and to the drying hopper; and a moisture sensor for determining a moisture content of the granular material at a location upstream of the drying hopper. At least one of the residence time of the granular material within the drying hopper, and the temperature, humidity, and flow rate of the process air are regulated based on the moisture content of the granular material measured upstream of the drying hopper at, for example, the storage vessel.

### CROSS-REFERENCE TO RELATED APPLICATIONS

This application claims the benefit of U.S. provisional application No. 63/406,836, filed 15 Sep. 2022, the contents of which are incorporated by reference herein in their entirety.

### BACKGROUND

Hygroscopic materials in granular form often contain moisture that needs to be removed from the material before the material is processed. For example, resin granulates used in the manufacture of plastic products typically are subjected to a drying process to remove moisture that may be present in the granulates. Such moisture, if present during the molding process, can result in surface defects, bubbles, structural deficiencies, lack of color homogeneity, etc. in the final product.

The drying process typically is performed by loading the plastic resin granulates into a drying hopper, and introducing dry, warm process air into the hopper. The process air absorbs moisture from the resin granulates as the process air passes over the granulates. Prior to drying, the resin granulates may be held in a storage vessel such as a Gaylord box, a silo, a railcar, etc. The resin granulates may be transferred directly to the drying hopper from the storage vessel by a vacuum loader. Alternatively, the resin granulates may be transferred to a receiver that holds the granulates, and feeds the granulates the drying hopper in a controlled manner.

The manufacturers of resin granulates usually provide a recommended duration, or residence time; process-air temperature; and final granulate moisture content for the drying process, i.e., manufacturers typically provide a drying time and drying-air temperature that will result in an acceptable moisture level in the granulates at the end of the drying process. The recommended values for duration (residence time) and process-air temperature are conservative, to help ensure that the granulates reach the recommended final moisture level regardless of the moisture level in the granulates at the start of the drying process, i.e., the time and temperature are chosen so that granulates having an initial moisture level at or near the maximum acceptable value will leave the drying hopper with a targeted moisture level acceptable for the subsequent processing operation. Thus, resin granulates having an initial moisture level below the maximum acceptable value may be dried for a longer period of time, and/or at a higher temperature than is necessary to dry the granulates sufficiently. In such cases, the throughput and/or energy usage of the dryer are less than optimal, leading to higher energy costs than necessary and/or lower production rates than otherwise could be achieved. Also, resin granulates with a relatively low initial moisture level may be over-dried, which can result in deficiencies in the products manufactured from the granulates.

The measurement and use of the initial moisture level to control the drying parameters of drying hoppers is known. In such systems, however, the moisture level is measured at the hopper as the resin granulates are entering the hopper. Thus, in the event the initial moisture level is out of specification, i.e., when the initial moisture level is too high for the drying capacity of the drying hopper, the out-of-specification granulates need to be discarded, or processed to bring the initial moisture level within the capacity of the drying hopper. Also, because the initial moisture level is not known until the granulates enter the drying hopper of these systems, the drying parameters of the hopper cannot be adjusted until the resin granulates are in the drying hopper, i.e., the drying parameters cannot be controlled prospectively so that the drying parameters are optimized for the particular resin granulates entering the drying hopper.

### SUMMARY

In one aspect, the disclosed technology relates to a system for drying a granular material. The system includes a drying hopper having a body defining an interior volume configured to receive the granular material, and a diffuser configured to direct process air into the interior volume. The system also includes a moisture sensor configured to, during operation, determine a moisture content of the granular material at a location upstream of the drying hopper. The system further includes a controller communicatively coupled to the moisture sensor and configured to, during operation, regulate a residence time of the granular material within the drying hopper and at least one of a temperature of the process air; a humidity of the process air; and a flow rate of the process air, based on the measured moisture content of the granular material.

In another aspect of the disclosed technology, the system further includes the storage vessel.

In another aspect of the disclosed technology, the storage vessel is one of a Gaylord box, an octobin, a remote storage vessel, a railcar, and a silo.

In another aspect of the disclosed technology, the system further includes a vacuum source configured to, during operation, transfer the granular material from the storage vessel and to the drying hopper.

In another aspect of the disclosed technology, the system further includes a dry air generator in fluid communication with the drying hopper and configured to, during operation, remove moisture from the process air.

In another aspect of the disclosed technology, the system further includes a heater in fluid communication with the drying hopper and the dry air generator. The heater is configured to, during operation, heat the process air.

In another aspect of the disclosed technology, the system further includes a blower in fluid communication with the drying hopper, the dry air generator, and the heater. The blower is configured to, during operation, circulate the process air between the drying hopper, the dry air generator, and the heater.

In another aspect of the disclosed technology, the system further includes a pickup wand in fluid communication with the vacuum receiver or the vacuum loader. The pickup wand is configured to draw the granular material from the storage vessel; and the moisture sensor is mounted on the pickup wand.

In another aspect of the disclosed technology, the vacuum source is one of a vacuum receiver and a vacuum loader.

In another aspect of the disclosed technology, the controller is further configured to, during operation, change the residence time from a manufacturer-recommended value to reach a target moisture content provided by the manufacturer, based on the measured moisture content of the granular material.

In another aspect of the disclosed technology, the controller is further configured to, during operation, change a temperature of the process air from a manufacturer-recommended value to reach the target moisture content provided by the manufacturer, based on the measured moisture content of the granular material.

In another aspect of the disclosed technology, the controller is further configured to, during operation, regulate the residence time of the granular material within the drying hopper; and at least one of: the temperature of the process air; the humidity of the process air; and the flow rate of the process air, based on the measured moisture content of the granular material and a predetermined relationship between the moisture content of the granular material and at least one of the residence time of the granular material within the drying hopper; the temperature of the process air; the humidity of the process air; and the flow rate of the process air.

In another aspect of the disclosed technology, the moisture sensor is mounted on the vacuum receiver or the vacuum loader.

In another aspect of the disclosed technology, the granular material includes one or more of resin granulates, a powdered material, and an agricultural grain.

In another aspect of the disclosed technology, the system further includes at least one load cell mechanically coupled to the drying hopper and communicatively coupled to the controller, the at least one load cell being configured to generate an output relating to a combined weight of the drying hopper and the granular material residing within the drying hopper.

In another aspect of the disclosed technology, the system further includes at least one level sensor mechanically coupled to the drying hopper and communicatively coupled to the controller, the at least one level sensor being configured to generate an output relating to a level of the granular material residing within the drying hopper.

In another aspect of the disclosed technology, the vacuum source is a vacuum receiver, and the system further includes at least one load cell mechanically coupled to the vacuum receiver and communicatively coupled to the controller, the at least one load cell being configured to generate an output relating to a combined weight of the vacuum receiver and the granular material residing within the vacuum receiver.

In another aspect of the disclosed technology, a process for drying a granular material includes providing a storage vessel configured to hold the granular material; and providing a drying hopper comprising a body defining an interior volume configured to receive the granular material, and a diffuser configured to direct process air into the interior volume. The process further includes transferring the granular material from the storage vessel and to the drying hopper; and measuring a moisture content of the granular material upstream of the drying hopper. The process also includes regulating a residence time of the granular material within the drying hopper and at least one of a temperature of the process air; a humidity of the process air; and a flow rate of the process air, based on the measured moisture content of the granular material.

In another aspect of the disclosed technology, measuring the moisture content of the granular material upstream of the drying hopper includes measuring the moisture content of the granular material at the storage vessel.

In another aspect of the disclosed technology, the process further includes providing a vacuum source configured to transfer the granular material from the storage vessel and to the drying hopper.

In another aspect of the disclosed technology, the process further includes providing a pickup wand in fluid communication with the vacuum source; and immersing an end of the pickup wand in the granular material within the storage vessel.

In another aspect of the disclosed technology, the process further includes providing a moisture sensor mounted on the pickup wand; and measuring the moisture content of the granular material upstream of the drying hopper using the moisture sensor.

In another aspect of the disclosed technology, the process further includes regulating at least one of: the residence time of the granular material within the drying hopper; the temperature of the process air; the humidity of the process air; and the flow rate of the process air, based on the measured moisture content of the granular material and a predetermined relationship between the moisture content of the granular material and at least one of the residence time of the granular material within the drying hopper; the temperature of the process air; the humidity of the process air; and the flow rate of the process air.

In another aspect of the disclosed technology, the process further includes providing a dry air generator in fluid communication with the drying hopper and configured to, during operation, remove moisture from the process air; and providing a heater in fluid communication with the drying hopper and the dry air generator, the heater being configured to, during operation, heat the process air. The process further includes providing a blower in fluid communication with the drying hopper, the dry air generator, and the heater. The blower is configured to, during operation, circulate the process air between the drying hopper, the dry air generator, and the heater.

In another aspect of the disclosed technology, the process further includes providing the granular material in the form of one or more of resin granulates, a powdered material, and agricultural grains.

In another aspect of the disclosed technology, the process further incudes changing the residence time from a manufacturer-recommended value to reach a target moisture content provided by the manufacturer, based on the measured moisture content of the granular material.

In another aspect of the disclosed technology, the process further includes changing a temperature of the process air from a manufacturer-recommended value to reach the target moisture content provided by the manufacturer, based on the measured moisture content of the granular material.

### BRIEF DESCRIPTION OF THE DRAWINGS

The following drawings are illustrative of particular embodiments of the present disclosure and do not limit the scope of the present disclosure. The drawings are not to scale and are intended for use in conjunction with the explanations provided herein. Embodiments of the present disclosure will hereinafter be described in conjunction with the appended drawings.

FIG. 1 is a diagrammatic illustration of a system for drying granular materials.

FIG. 2 is a diagrammatic illustration of various electrical, electronic, and electromechanical components of the system shown in FIG. 1.

FIG. 3 is a side, partial cutaway view of a drying hopper of the system shown in FIGS. 1 and 2.

FIG. 4 is a side view of a vacuum receiver of the system shown in FIGS. 1-3.

FIG. 5 is a side view of a dry air generator of the system shown in FIGS. 1-4.

FIG. 6 is a side, partial cutaway view of a pickup wand of the system shown in FIGS. 1-5.

FIG. 7 is a side, partial cutaway view of a storage vessel for use with the system shown in FIGS. 1-6, depicting the pickup wand shown in FIG. 6 drawing resin granulates from the storage vessel.

FIG. 8 is a flow diagram depicting operation of the system show in FIGS. 1-7.

### DETAILED DESCRIPTION

The inventive concepts are described with reference to the attached figures, wherein like reference numerals represent like parts and assemblies throughout the several views. The figures are not drawn to scale and are provided merely to illustrate the instant inventive concepts. The figures do not limit the scope of the present disclosure or the appended claims. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

The figures depict a system 10 for drying a granular material. The system 10 can be used to remove moisture from, for example, granulates 11 of thermoplastic resin used in injection molding machines to manufacture plastic products. The resin granulates 11 are depicted in FIG. 7. This particular application is disclosed for illustrative purposes only. The system 10, and alternative embodiments thereof, can be used to dry other types of granular materials including, for example, agricultural products such as grains. Also, the term “granular material,” as used herein, is intended to encompass powered materials including, without limitation, powered materials used in the pharmaceutical industry.

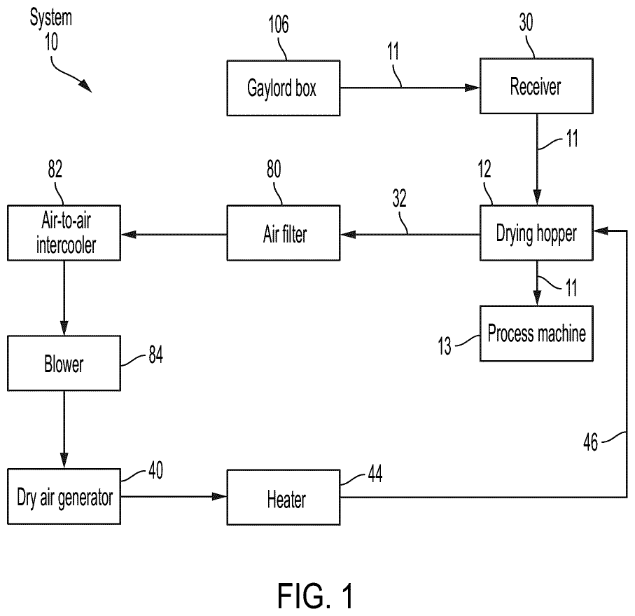

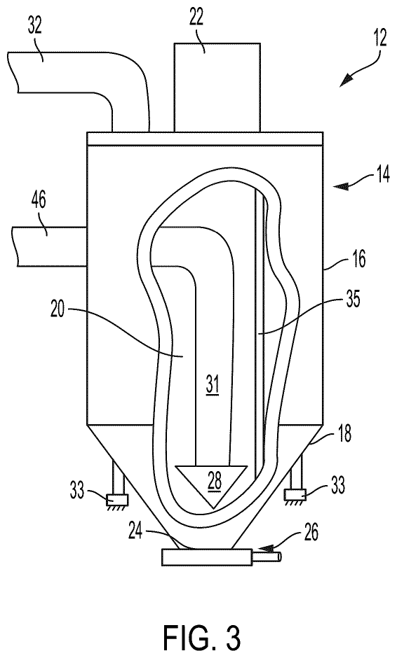

Referring to FIGS. 1 and 3, the system 10 includes a drying hopper 12. The drying hopper 12 is configured to hold the granular material, i.e., the resin granulates 11, and to direct dry, heated air over the granulates 11 to remove moisture from the granulates 11. After being dried in the hopper 12, the resin granulates 11 are transferred to a process machine 13, such as an injection molding machine that processes the granulates 11 into plastic products.

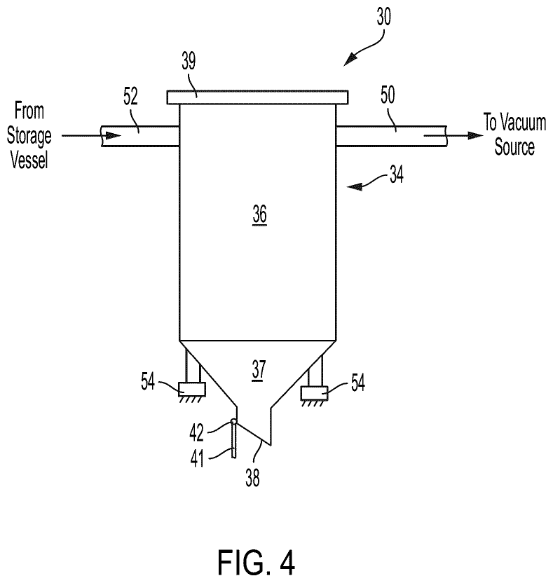

The system 10 also includes a vacuum receiver 30 mounted above the hopper 12. The vacuum receiver 30 is depicted FIGS. 1 and 4. The vacuum receiver 30 receives the resin granulates 11 from a storage vessel such as a Gaylord box 106 shown in FIG. 7, a container, a silo, a railcar, an octobin, etc. The receiver 30 holds the resin granulates 11 until the drying hopper 12 requires the addition of granulates 11 during the initial loading process; and during the drying cycle when the resin granulates 11 within the drying hopper 12 need to be replenished as dried resin granulates 11 are discharged from the drying hopper 12.

The moisture content of the resin granulates 11 is measured at the storage vessel, as the resin granulates 11 are being drawn from the storage vessel for transfer to the receiver 30. The system 10 is configured to adjust various operating parameters of the hopper 12, including the residence or drying time of the granulates 11 within the hopper 12, based on the as-measured initial moisture content of the resin granulates 11, with the goal of reaching a recommended or target value for the moisture content at the end of the drying process. The system 10 thus can tailor the drying time and the energy usage to the initial moisture content of the resin granulates 11, so that the drying time can be reduced, energy usage can be optimized, and the potential for over-drying the resin granulates 11 can be reduced or virtually eliminated. In addition, the operating parameters of the drying hopper 12 can be adjusted prospectively, before the resin granulates 11 reach the drying hopper 12, so that the operating parameters can be optimized for the actual moisture content of the resin granulates 11 as the resin granulates 11 enter the drying hopper 12.

Also, because the moisture level of the resin granulates 11 is measured at the storage vessel, in the event the moisture level is out of specification, i.e., when the moisture level is too high for the drying capacity of the drying hopper 12 in view of the target moisture level to which the granulates 11 are to be dried, the loading process can be interrupted before the out-of-specification resin granulates 11 have been transferred to the drying hopper 12. The ability to prevent out-of-specification granulates 11 from being loaded into the drying hopper 12 can help avoid the downtime, production delays, and expense associated with removing such granulates 11 from the drying hopper 12 so that the granulates 11 can be brought within specification before being re-loaded into the drying hopper 12, or discarded.

### Drying Hopper

The drying hopper 12 is positioned on, and supported by a fixed support structure (not shown). The drying hopper 12 can be positioned on a mobile trolley in alternative embodiments. The drying hopper 12 is positioned over the process machine 13, and supplies the resin granulates 11 to the process machine 13 on a selective basis. The process machine 13 can be, for example, an injection molding machine that transforms the resin granulates 11 into a molten state, and forms plastic objects from molten resin.

Referring to FIG. 3, the drying hopper 12 comprises a body 14 having a cylindrical upper section 16, and a cone-shaped lower section 18 connected to the upper section 16. The upper section 16 and the lower section 18 define an interior volume 20 in which the resin granulates 11 reside during the drying process. The drying hopper 12 also includes a feed mouth 22 located at the top of the upper section 16, and an output mouth 24 located at the bottom of the lower section 18. Resin granulates 11 enter the interior volume of the drying hopper 12 by way of the feed mouth 22, and exit the drying hopper 12 at the conclusion of the drying process by way of the output mouth 24.

The drying hopper 12 also may include a discharge valve 26 located proximate the output mouth 24. The discharge valve 26 can be, for example, an electrically-actuated gate valve that moves between a closed position and an open position. When in the closed position, the discharge valve 26 covers the bottom of the output mouth 24, thereby preventing the resin granulates 11 in the interior volume 20 from exiting the drying hopper 12. When in the open position, the discharge valve 26 allows the dried resin granulates 11 to exit the drying hopper 12 by way of the output mouth 24. The dried resin granulates 11 exiting the drying hopper 12 can drop or be conveyed into a process machine 13, such as an injection molding machine, located below the drying hopper 12. The resin granulates 11 thus travel from the top to the bottom of the drying hopper 12 during the drying cycle.

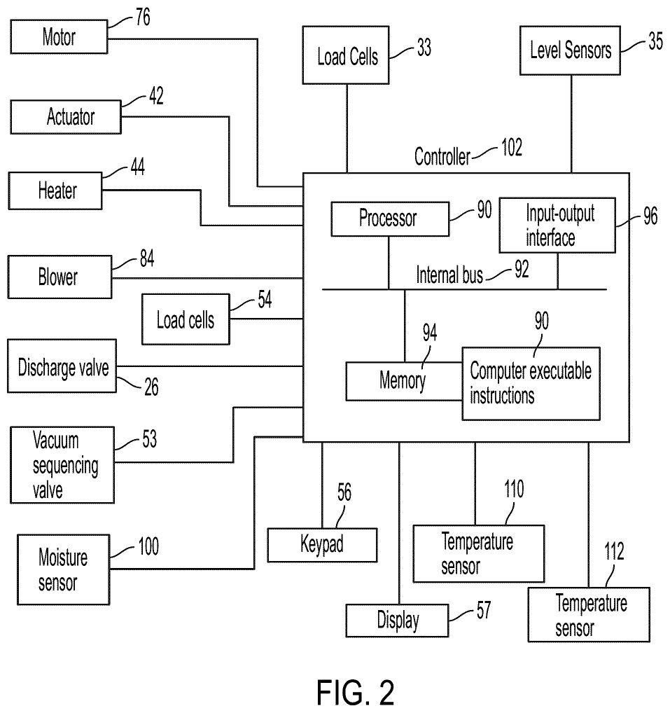

The discharge valve 26 is communicatively coupled to a controller 102 of the system 10, as shown in FIG. 2. The controller 102 controls the discharge of the resin granulates 11 from the drying hopper 12. In particular, the controller 102 is configured to generate inputs that cause the discharge valve 26 to open and close in response to user inputs; and when the controller 102 determines that the resin granulates 11 in the lower portion of the interior volume 20 have been subjected the drying process for a sufficient period of time to dry the resin particles.

The drying hopper 12 also includes a diffuser 28, visible in FIG. 3. The diffuser 28 is suspended within the interior volume 20, proximate the bottom of the lower section 18 of the body 14, by a delivery duct 31. The delivery duct 31 directs heated and dry, e.g., −40° F. dewpoint, process air to the diffuser 28. The diffuser 28 directs the process air outward, in a 360-degree pattern, so that the process air is distributed in a substantially symmetric pattern around the diffuser 28. The process air rises evenly through the interior volume 20, and passes over the resin granulates 11 residing in the interior volume 20. Upon contacting the resin granulates 11, the process air removes moisture from the resin granulates 11. The process air eventually reaches the upper end of the interior volume 20, where the process air, now laden with moisture released from the resin granulates 11, exits the drying hopper 12 by way of a return duct 32.

The drying hopper 12 also includes a weight sensing means in the form of, for example, one or more load cells 33 mounted between the body 14 and the support structure of the drying hopper 12. The load cells 33 are depicted in FIGS. 2 and 3. The load cells 33 are communicatively coupled to the controller 102, and generate outputs relating to the combined weight of the drying hopper 12 and its contents, i.e., the resin granulates 11 residing within the drying hopper 12. The controller 102 is configured to calculate the combined weight of the drying hopper 12 and its contents based on the outputs of the load cells 33, and predetermined calibration data stored in the controller 102. The controller 102 then can calculate the total weight of the resin granulates 11 residing in the drying hopper 12 based on the combined weight of the drying hopper 12 and its contents, and the empty weight of the drying hopper 12. Alternative embodiments of the system 10 can be configured without the load cells 33.

The drying hopper 12 also includes one or more level sensors 35 mounted within the interior volume 20 of the body 14, or at other suitable locations on or proximate the body 14. The level sensors 35 are depicted in FIGS. 2 and 3. The level sensors 35 can be, for example, level switches. The level sensors 35 are communicatively coupled to the controller 102, and generate outputs indicating the level of the resin granulates 11 within the interior volume 20. Alternative embodiments of the system 10 can be configured without the level sensors 35.

As discussed below, the controller 102 can use the readings from the load cells 33 and/or the level sensors 35 to monitor the weight of the resin granulates 11 passing through the drying hopper 12, to vary the residence time of the resin granulates 11 in the drying hopper 12.

### Dry Air Generator

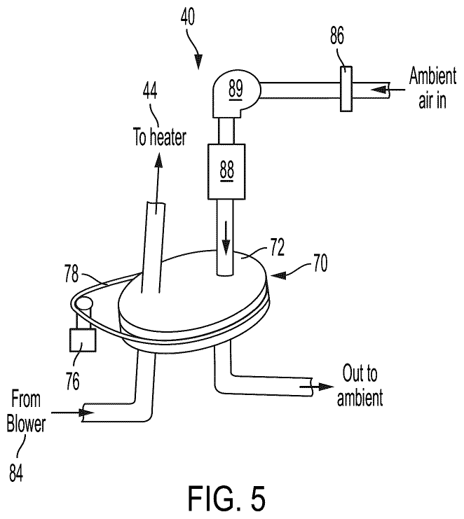

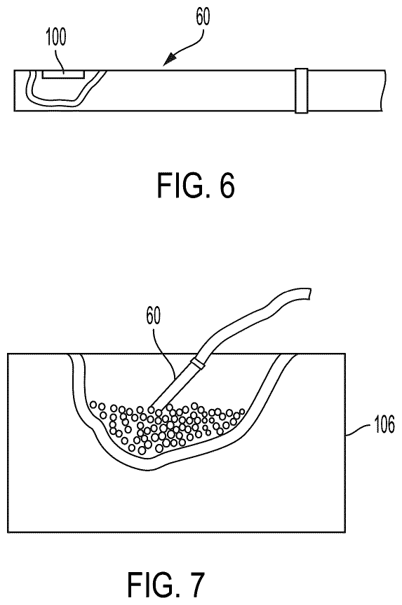

The system 10 further includes a dry air generator 40, shown in FIGS. 1 and 5. The dry air generator 40 is fluidly connected to the drying hopper 12 by way of the return duct 32, so that the drying hopper 12 receives the moisture-laden air that exits the drying hopper 12.

The dry air generator 40 dehumidifies the moisture-laden air exiting the drying hopper 12, so that the dried air can be recirculated to the drying hopper 12 and once again used to remove moisture from the resin granulates 11 within the drying hopper 12. The dry air generator 40 can be, for example, a desiccant dryer in which the process air, i.e., the moisture-laden air received from the drying hopper 12, is exposed to a desiccant material that absorbs moisture from the process air.

The dehumidified process air leaving the dry air generator 40 has a very low humidity. For example, the process air can have a dewpoint of −40° F. As discussed below, the humidity or dewpoint of the process air is an operating parameter of the system 10 that can be adjusted by the controller 102 based on the moisture level of the resin granulates 11 entering the drying hopper 12, to help reduce drying time and optimize energy usage.

The dry air generator 40 can be, as a non-limiting example, a rotary wheel desiccant dryer. The use of a rotary wheel desiccant dryer, and the following description of such a dryer, are disclosed for illustrative purposes only. Other types of desiccant dryer configurations, such as a dual bed configuration, can be used in lieu of the rotary wheel configuration. Also, other types of dry air generators that do not use desiccant, such as vacuum dryers, membrane dryers, infrared dryers, etc., can be used in lieu of a rotary wheel desiccant dryer.

Referring to FIG. 5, the dry air generator 40 comprises a desiccant wheel 70 having a rotor 72, and desiccant material 74 impregnated on the rotor 72. The dry air generator 40 also includes a variable-speed motor 76 communicatively coupled to the controller 102. The motor 76 is configured to rotate the rotor 72 on a continuous basis during the drying process, by way of a drive belt 78.

The desiccant wheel 70 rotates through two airstreams: a process airstream made up of the relatively cool, moisture-laden air received by the dry air generator 40 from the drying hopper 12; and a regeneration airstream.

Referring to FIG. 1, the process air exiting the drying hopper 12 is directed to the dry air generator 40 by way of the return duct 32; an air filter 80 that removes fines and other particulate matter from the process air; and an air-to-air intercooler 82 that reduces the temperature of the process air; and a blower 84 that circulates the process air between the drying hopper 12 and the dry air generator 40.

Upon entering the dry air generator 40, the process air passes through a first, or process sector of the rotor 72, where the desiccant material absorbs sufficient moisture from the process air so that the process air leaves the dry air generator 40 with very low humidity, as reflected by the dewpoint of the process air. As discussed below, the dewpoint of the process air exiting the dry air generator (“T_{DP}”) is an operating parameter of the system 10, and can be selected by the controller 102 based on the moisture level in the resin granulates 11 as measured at the storage vessel, i.e., at the Gaylord box 106. T_{DP} can be controlled, for example, by varying the rotational speed of the desiccant wheel 70 or the regeneration-air temperature, via control inputs to the motor 76 generated by the controller 102. T_{DP} can be controlled by other means in alternative embodiments.

The desiccant material 74 is regenerated by the regeneration airstream, which is directed through a second, or regeneration sector of the rotating desiccant wheel 70. The regeneration airstream is generated by a regeneration circuit of the dry air generator 40. The regeneration circuit comprises a regeneration air filter 86 that receives and filters ambient air, and a regeneration heater 88 that heats the filtered regeneration airstream.

The regeneration circuit further comprises a regeneration blower 89 in fluid communication with the regeneration heater 88. The regeneration blower 89 directs the heated regeneration airstream through the regeneration sector of the desiccant wheel 70. The heating of the desiccant material 74 by the regeneration airstream releases the moisture in the desiccant material 74. The moisture is carried out of the dry air generator 40 by the regeneration airstream, which is exhausted into the ambient environment.

After exiting the dry air generator 40, the low-dewpoint process air is returned to the drying hopper 12 by way of a heater 44 and a delivery duct 46. The heater 44 raises the temperature of the dried process air, to reduce the relative humidity of the air and further encourage moisture exchange between the process air and the resin granulates 11 in the drying hopper 12. The heater 44 can be, for example, a resistance heater. Other types of heaters can be used in alternative embodiments.

After being heated, the process air is returned to the drying hopper 12 via the delivery duct 46, which is fluidly connected at one end to the heater 44, and at the other end to the delivery duct 31 of the drying hopper 12. The dry, heated process air enters the interior volume 20 of the drying hopper 12 by way of the delivery duct 31 and the diffuser 28, and removes moisture from the resin granulates 11 within the drying hopper 12 as discussed above.

### Receiver

Referring to FIG. 4, the receiver 30 comprises a body 34 having a cylindrical upper section 36, and a cone-shaped lower section 37 that adjoins the upper section 36. The body 34 is positioned above the drying hopper 12, and is mounted on a support structure (not shown). The upper section 36 and the lower section 37 define an interior volume in which the resin granulates 11 are held. The lower section 37 defines an opening, or dump throat 38, located at the bottom of the lower section 37. The resin granulates 11 exit the receiver 30 by way of the dump throat 38. The receiver 30 also includes a lid 39 coupled to the upper section 36 of the body 34 by pins or other suitable means that permit the lid 39 to rotate in relation to the body 34.

The receiver 30 further includes a discharge gate 41 coupled to the bottom of the lower section 37. The discharge gate 41 may be coupled to the lower section 37 and to an electric actuator 42 so that the discharge gate 41 can be rotated by the actuator 42 between a closed position and an open position. When in the closed position (not shown), the discharge gate 41 covers the dump throat 38 defined by the lower section 37, thereby preventing the resin granulates 11 in the interior volume of the body 34 from exiting the receiver 30. When in the open position, shown in FIG. 4, the discharge gate 41 no longer covers the dump throat 38, and thereby permits the resin granulates 11 to exit the receiver 30 and drop into the drying hopper 12 by way of the feed mouth of the drying hopper 12. Alternative embodiments can include a flapper or other means to seal the receiver during vacuum and material transfer, in lieu of the discharge gate 41.

The actuator 42 is communicatively coupled to the controller 102, as depicted in FIG. 2. As discussed below, the controller 102 is configured to generate inputs that cause the actuator 42 to open and close the discharge gate 41 in response to user inputs, and in response to a need to add resin granulates 11 to the drying hopper 12 as dried granulates 11 are discharged from the drying hopper 12 during the drying cycle.

The system 10 further incudes a first duct 50 and a second duct 52, as shown in FIG. 4. The first duct 50 is fluidly connected to the receiver 12, and to a vacuum source (not shown). The vacuum source is configured to generate a vacuum that is conveyed to the interior volume of the receiver 12 by way of the first duct 50. The receiver 40 comprises a vacuum sequencing valve 53, depicted in FIG. 2. The vacuum sequencing valve 53 is communicatively coupled to the controller 102, and isolates the interior volume of the receiver 12 from the first duct 50, and the vacuum source, on a selective basis.

The second duct 52 is fluidly connected to the receiver 30, and is in fluid communication with the storage vessel, i.e., the Gaylord box 106. The second duct 52 conveys the resin granulates 11 to the interior volume of the receiver 30 from the storage vessel, in response to the vacuum within the interior volume of the receiver 30. The resin granulates 11, upon entering the interior volume, fall toward the bottom of the interior volume. The receiver 12 is equipped with a filter (not shown) that filters dust and other fines from the air entering the first duct 50 from the interior volume in response to the vacuum within the first duct 50.

The receiver 30 also includes a weight sensing means in the form of, for example, one or more load cells 54 mounted between the body 34, and the support structure for the receiver 30. The load cells 54 are depicted in FIGS. 2 and 4. The load cells 54 are communicatively coupled to the controller 102, and generate outputs relating to the combined weight of the receiver 30 and its contents, i.e., the resin granulates 11 residing within the receiver 30. The controller 102 is configured to calculate the combined weight of the receiver 30 and its contents based on the outputs of the load cells 54, and predetermined calibration data stored in the controller 102. The controller 102 then can calculate the total weight of the resin granulates 11 residing in the receiver 30 based on the combined weight of the receiver 30 and its contents, and the empty weight of the receiver 30. As discussed below, the controller 102 can use the readings from the load cells 54 to monitor the weight of the resin granulates 11 passing through the receiver 30, to vary the residence time of the resin granulates 11 in the drying hopper 12. Alternative embodiments of the system 10 can be configured without the load cells 54.

The fill and discharge operations of the receiver 30 can be performed in a manual mode or an automatic mode. A manual fill operation can be commenced by the user by pressing a button on an actual or virtual keypad 56 communicatively coupled to the controller 102. The keypad 56 is depicted in FIG. 2. Upon receiving the input, the controller 102 issues an output that, when received by the actuator 42, causes the actuator 42 to close the discharge gate 41. In addition, the controller 102 issues an input that, when received by the vacuum sequencing valve 53, causes the vacuum sequencing valve 53 to open, thereby placing the interior volume of the receiver 30 in fluid communication with the vacuum source, which in turn causes resin granulates 11 in the Gaylord box 106 to be drawn into a tubular pickup wand 60, as discussed below, and transported to the receiver 30.

Similarly, the controller 102 can commence an automated fill operation by issuing inputs that cause the discharge gate 41 to close, and the vacuum sequencing valve 53 to open, resulting in the transfer of resin granulates 11 to the receiver 30 from the Gaylord box 106. The automated fill operation can be performed after resin granulates 11 have been discharged from the receiver 30 to the drying hopper 12. In addition, or alternatively, the automated fill operation can be performed to maintain a predetermined level of resin granulates 11 in the receiver 30, as detected by a sensor (not shown) within in the receiver 30.

A manual discharge operation likewise can be commenced by the user by pressing a button on the keypad 56. Upon receiving the input, the controller 102 issues an output that causes the vacuum sequencing valve 53 to close, thereby isolating the interior volume of the receiver 30 from the vacuum source. In addition, the controller 102 issues an output that causes the actuator 42 to open the discharge gate 41, which in turn allows the resin granulates 11 residing within the interior volume of the receiver 30 to fall out of the receiver 30 via the dump throat 38, and into the interior volume 20 of the drying hopper 12.

Similarly, the controller 102 can commence an automated discharge operation by issuing inputs that cause the vacuum sequencing valve 53 to open, and the discharge gate 41 to open. The automated fill operation can be performed as dried resin granulates 11 are being discharged from the drying hopper 12. In addition, or alternatively, the automated fill operation can be performed to maintain a predetermined level of resin granulates 11 in the drying hopper 12, as detected by a sensor (not shown) within the drying hopper 12.

Specific details of the receiver 30 are presented for illustrative purposes only. The receiver 30 can have other configurations in alternative embodiments. Also, the use of the receiver 30 to convey the resin granulates 11 to the drying hopper 12 is disclosed for illustrative purposes only. Other conveying means, such as a vacuum loader, can be used in the alternative. Also, the receiver 30 can be connected to one or more storage vessels by a centralized conveying system.

As noted above, the resin granulates 11 are held in a storage vessel prior to being transferred to the receiver 30. The storage vessel can be, for example, a Gaylord box 106 of the type typically used to store, handle, and transport resin granulates 11. The system 10 can be used in conjunction with other types of storage vessels, including silos, railcars, etc. The storage vessel, i.e., the Gaylord box 106, can be located adjacent to, or otherwise close to the receiver 30 and the drying hopper 12, and as discussed above, the resin granulates 11 can be transferred from the storage vessel and to the receiver 30 via the second duct 52. Alternatively, the storage vessel can be located distally from the hopper 12. For example, the storage vessel can be located in a remote storage area of a plastics manufacturing facility, and the resin granulates 11 can be transferred from the storage vessel and to the receiver 30 by way of a centralized conveying system.

The resin granulates 11 can be drawn from the Gaylord box 106 by the pickup wand 60. The pickup wand 60 can be connected to the second duct 52 by a flexible hose or tubing, or other suitable means. During transfer of the resin particles to the receiver 30 from the Gaylord box 106, the forward end of the pickup wand 60 is immersed in the resin granulates 11. The vacuum sequencing valve 53 of the receiver 30 is actuated, i.e., opened, at the start of the loading process, to place the interior volume of the receiver 30 in fluid communication with the vacuum source. The resulting vacuum within the interior volume is conveyed to the pickup wand 60 by way of the second duct 52. The vacuum causes resin granulates 11 adjacent the end of the pickup wand 60 to be drawn into the pickup wand 60. The resin granulates 11 subsequently enter the second duct 52, and are conveyed to the interior volume of the receiver 30 by the vacuum within the second duct 52. The resin granulates 11 can be drawn from the Gaylord box 106 by means other than the pickup wand 60, in alternative embodiments.

### Controller

Referring to FIG. 2, the controller 102 comprises a processor 90, such as a microprocessor; an internal bus 92; a memory 94 communicatively coupled to the processor 90 via the bus 92; computer-executable instructions 98 stored in the memory 94; and an input-output interface 96 communicatively coupled to the internal bus 92. The controller 102 can have other configurations in alternative embodiments. Also, the controller 102 can include additional components, a description of which is not necessary to an understanding of the disclosed technology. As discussed below, the controller 102 can be configured to optimize the residence time of the resin granulates 11 in the drying hopper 12 using the weight or level of the resin granulates 11 in the drying hopper 12, or other methodologies.

### Moisture Sensor

The system 10 further comprises a moisture sensor 100 communicatively coupled to the controller 102. The moisture sensor 100 is located upstream of the feed mouth 22 of the drying hopper 12. For example, the moisture sensor 100 can be mounted inside the pickup wand 60, so that the moisture sensor 100 contacts the resin granulates 11 as the resin granulates 11 are drawn into the pickup wand 60 during transfer to the receiver 30. The moisture sensor 100 can be mounted at other locations upstream of the feed mouth 22 of the drying hopper 12 in alternative embodiments of the system 10. For example, the moisture sensor 100 can be mounted in the vacuum receiver 30 in alternative embodiments.

The moisture sensor 100 measures the moisture content of the resin granulates 11 on an on-line basis, i.e., in real-time or near real-time. The moisture sensor 100 thus provides the controller 102 with an indication of the moisture content of the resin granulates 11 before the granulates 11 reach the drying hopper 12. As discussed below, the controller 102 prospectively adjusts the operating parameters of the drying hopper 12 to tailor the drying time and the energy usage of the drying hopper 12 to the as-measured moisture level of the resin granulates 11.

The moisture sensor 100 is a capacitive sensor. Other types of moisture sensors can be used in alternative embodiments. For example, the moisture sensor 100 can be a microwave sensor, an infrared sensor, a dielectric sensor, etc.

The moisture sensor 100 can be calibrated prior to use, and periodically thereafter, using moisture readings obtained from highly accurate off-line moisture measurement techniques such as Karl Fischer titration. The calibration curve can be stored in the memory 94 of the controller 102, and applied to the on-line moisture readings obtained from the moisture sensor 100.

### Operation

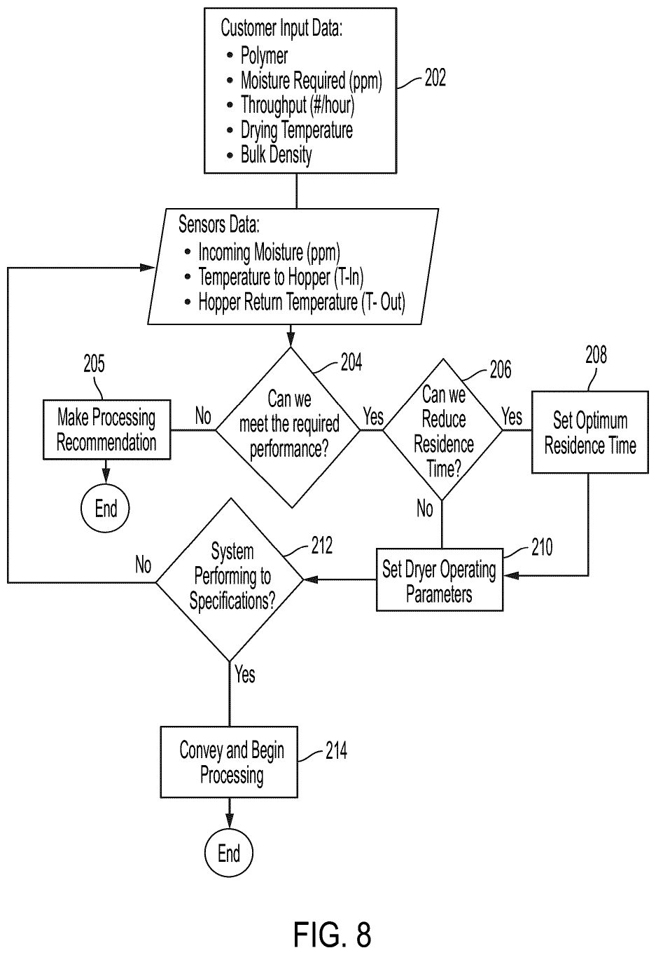

FIG. 8 is a flow diagram depicting operation of the system 10. Initial operator inputs are entered and provided to the controller 102 via the keypad 56 (step 202 of FIG. 8). These inputs include the type of polymer to be dried; the targeted moisture level in the resin granulates 11 at the conclusion of the drying process, i.e., a final moisture level, in parts per million (ppm); the throughput of resin granulates 11 through the drying hopper 12, in pounds per hour; and the drying temperature, i.e., the temperature of the dried and heated air entering the drying hopper 12 (“T_{IN}”), as measured by a temperature sensor 110 located within the delivery duct 46. The temperature sensor 110 is depicted in FIG. 2.

The final moisture level can be, for example, a moisture level recommended by the granulate manufacturer to ensure that the resin granulates 11 are sufficiently dry for subsequent processing operations such as injection molding. The value of T_{IN} initially input to the system 10 likewise can be, for example, a manufacturer-recommended value chosen to help ensure adequate drying of the granulates 11.

The controller 102 receives, from the moisture sensor 100, readings of the moisture level of the resin granulates 11 in the storage vessel, i.e., the Gaylord box 106. The initial moisture readings can be obtained before the initial batch of resin granulates 11 is transferred to the receiver 30 from the Gaylord box 106. The controller 102 also receives a reading of T_{IN} from the temperature sensor 110. Also, the controller 102 receives a reading of the temperature of the air exiting the interior volume 20 of the drying hopper 12 (“T_{OUT}”), from a temperature sensor 112 located in the return duct 32. The temperature sensor 112 is depicted in FIG. 2.

The controller 102, executing the computer-executable instructions 98, determines whether the system 10 is capable of drying the resin to the desired final moisture level, at the throughput value and the value of T_{IN} that have been input by the operator (step 204 of FIG. 8). The computer-executable instructions 98 can make this determination based on the initial moisture content of the resin granulates 11 as measured by the moisture sensor 100; the relevant properties of the material from which the resin granulates 11 are formed; and the drying capacity the drying hopper 12.

If the controller 102 determines that the system 10 is not capable of drying the resin granulates 11 in accordance with the input parameters entered into the system 10, the controller 102 generates and sends to a user interface, e.g., a display 57 depicted in FIG. 2, a recommendation for adjusting one or more of the input parameters, including one or more of throughput, T_{IN}, or the final moisture level, to levels that will permit the system 10 to perform the drying operation (step 205). Based on this recommendation, the operator can repeat the input process, entering new values for one or more of throughput, T_{IN}, and final moisture level, where the new values have been determined by the system 10 to be within the drying capacity of the drying hopper 12.

If the moisture level of the resin granulates 11 in the Gaylord box 106 exceeds the drying capacity of the system 10, i.e., if the resin granulates 11 are out of specification for the system 10 and cannot be dried to a satisfactory level regardless of the combination of input parameters entered into the system 10, the system 10 notifies the operator, via the display 57, that the resin granulates 11 in that particular Gaylord box 106 are out of specification and cannot be dried at that time. Also, the system 10, thorough the controller 102, can be configured to provide alternate suggestions that would allow the out-of-specification resin granulates 11 to be dried.

Because the moisture level of the resin granulates 11 is measured upstream of the drying hopper 12 and is available to the controller 102 on a real-time or near real-time basis, the controller 102 can identify out-of-specification resin granulates 11 before the resin granulates 11 are transferred to the drying hopper 12. The system 10 thus can prevent situations in which it is necessary to empty the drying hopper 12 to remove out of specification resin granulates 11 before the drying cycle has started; or after the drying cycle has commenced and it is subsequently determined that the resin particles cannot be dried to an acceptable level. Either of these scenarios can result in substantial production delays and increases in operating costs. Also, the incomplete drying of out-of-specification resin granulates 11 can result in resin granulates 11 entering the process machine 13 with a higher-than-acceptable moisture content, which in turn can result in end products that are defective or otherwise unsatisfactory.

Upon determining that the resin granulates 11 can be dried to the desired, i.e., target, moisture level based on the initial moisture level and the input parameters entered by the operator, the controller 102 makes a further determination of whether the residence time can be reduced from the manufacturer-recommended residence time (step 208 of FIG. 8). (The residence time typically is set by the following combination of variables: the throughput of the resin granulates 11; the bulk density of the resin granulates 11; and the total volume of the drying hopper 12.) For example, the memory 94 of the controller 102 can have stored therein a lookup table containing data representing a correlation or predetermined relationship between the values of T_{IN}, T_{DP}, throughput, airflow, i.e., the flow-rate of the process air, and residence time needed to achieve a particular reduction in the moisture content for the resin granulates 11 of a particular type, which in turn permits the controller 102 to predict the final moisture level of the granulates 11 if the initial moisture level, and the process parameters, e.g., throughput, T_{IN}, T_{DP}, residence time, etc., are known. If the controller 102 determines that the residence time can be reduced, production can be started earlier, and/or the fill level of the drying hopper 12 can be lowered.

After adjusting the residence time based on information from the load cells 33, level sensors 35, load cells 53, and/or other means, or determining that the manufacturer-recommended residence time, or a similar value, should be used, the system 10 generates inputs to the blower 43, the heater 44, and the dry air generator 40 to commence the flow of process air through the drying hopper 12 (step 210). (Although the dry air generator 40 already may be running, its operating parameters nevertheless may be adjusted at this point). Upon verifying that the process parameters, i.e., T_{IN}, T_{DP}, and the flowrate of the process air, are at their targeted levels (step 212), the controller 102 generates an input that causes the actuator 42 to open the discharge gate 41 of the receiver 30, to begin introducing resin granulates 11 into the drying hopper 12 (step 214).

If the controller 102, as the system 10 is operating, determines that the target levels of one or more of the desired process parameters cannot be achieved (step 212), the controller 102 generates inputs that cause the blower 43, the heater 44, and the dry air generator 40 to deactivate, or the controller 102 proposes alternate production capabilities. In addition, the controller 102 generates and sends to the display 57 a recommendation for adjusting one or more of the input parameters, i.e., throughput, T_{IN}, or the final moisture level, to levels that will permit the system 10 to perform the drying operation (steps 214, 204, 205). Based on this recommendation, the operator can repeat the input process, entering the new recommended values for one or more of throughput, T_{IN}, and final moisture level.

The drying hopper 12 operates on a semi-continuous flow basis. The controller 102 thus controls the positioning of the discharge gate 41 of the receiver 30 so that the resin granulates 11 are loaded into the drying hopper 12 at a rate corresponding to the targeted throughput of the resin granulates 11.

When the targeted residence time has elapsed following the initial introduction of resin granulates 11 into the drying hopper 12, the controller 102 commands the opening of the discharge valve 26 of the drying hopper 12, so that the dried resin granulates 11 can exit the hopper 12 at a rate corresponding to the targeted throughput of the resin granulates 11. At this point, the dried resin granulates 11 continuously exit the bottom of the drying hopper 12 at a rate corresponding approximately to the targeted throughput; and resin granulates 11 are added continuously through the top of the drying hopper 12 at about the same rate. Thus, all of the resin granulates 11 introduced in the drying hopper 12 are exposed to the process air within the interior volume 20 of the drying hopper 12 for the required residence time. As noted above, the controller 102 can predict the final moisture level in the resin granulates 11 if the initial moisture level and the process parameters, including residence time, are known. Thus, the system 10, by regulating the residence time and one or more of the other process parameters based on the initial moisture content of the resin granulates 11, dries the resin granulates 11 to a level at or near the manufacturer-recommended value or other targeted value input to the system 10.

The drying hopper 12 can be configured to operate on a batch basis in alternative embodiments.

Resin granulates 11 are transferred to the receiver 30 from the Gaylord box 106 periodically during the drying cycle, to replenish the resin granulates 11 being added to the drying hopper 12 from the receiver 30. The controller 102 continuously monitors the moisture level of the resin granulates 11 being transferred to the receiver 30, as measured by the moisture sensor 100. Changes in the moisture level can occur, for example, when the resin granulates 11 are drawn from the lower levels of the Gaylord box 106, where the resin granulates 11 are more susceptible to picking up moisture from standing water at the bottom of a Gaylord box 106 that had not been protected properly from the elements. Also, the moisture level of the granulates 11 reaching the receiver 30 can change when the Gaylord box 106 from which the granulates 11 are drawn is changed.

Upon detecting the change in the moisture level of the resin granulates 11 being drawn from the Gaylord box 106, the controller 102 adjusts the residence time, and one or more of T_{DP}, T_{IN}, and airflow, to achieve the desired final moisture level in the resin granulates 11 in view of the change in the initial moisture level. The controller 102 makes these adjustments based on the above-noted predetermined relationship between T_{IN}, T_{DP}, throughput, airflow, and residence time needed to achieve a particular reduction in the moisture content for resin granulates 11 of a particular type.

The on-line measurement of the initial moisture content of the resin granulates 11 at the storage vessel, i.e., at the Gaylord box 106, upstream of drying hopper 12, allows the controller 102 to adjust the process parameters of the drying hopper 12 so that the process parameters are at an optimal level for the specific moisture level of the resin granulates 11 being introduced into the drying hopper 12. Also, by reducing residence based on the initial moisture levels, over-drying of the resin granulates 11 can be avoided; and the system 10 can begin production earlier and/or the level of the resin granulates 11 in the drying hopper 12 can be reduced. In addition, savings in energy costs potentially can be achieves by tailoring T_{DP}, T_{IN}, and/or the flow rate of the process air to the specific moisture content of the resin granulates 11 entering the drying hopper 12.

We claim:

1. A system for drying a granular material, comprising:
a drying hopper comprising a body defining an interior volume configured to receive the granular material from a storage vessel configured to hold the granular material, and a diffuser configured to direct process air into the interior volume;
a moisture sensor configured to, during operation, determine a moisture content of the granular material at a location upstream of the drying hopper; and
a controller communicatively coupled to the moisture sensor and configured to, during operation, regulate a residence time of the granular material within the drying hopper and at least one of a temperature of the process air; a humidity of the process air; and a flow rate of the process air, based on the measured moisture content of the granular material.

2. The system of claim 1, further comprising the storage vessel.

3. The system of claim 2, wherein the storage vessel is one of a Gaylord box, an octobin, a remote storage vessel, a railcar, and a silo.

4. The system of claim 1, further comprising a vacuum source configured to, during operation, transfer the granular material from the storage vessel and to the drying hopper.

5. The system of claim 1, further comprising a dry air generator in fluid communication with the drying hopper and configured to, during operation, remove moisture from the process air.

6. The system of claim 5, further comprising a heater in fluid communication with the drying hopper and the dry air generator, the heater being configured to, during operation, heat the process air.

7. The system of claim 6, further comprising a blower in fluid communication with the drying hopper, the dry air generator, and the heater, the blower being configured to, during operation, circulate the process air between the drying hopper, the dry air generator, and the heater.

8. The system of claim 4, wherein the vacuum source is one of a vacuum receiver and a vacuum loader.

9. The system of claim 8, further comprising a pickup wand in fluid communication with the vacuum receiver or the vacuum loader and configured to draw the granular material from the storage vessel; wherein the moisture sensor is mounted on the pickup wand.

10. The system of claim 1, wherein the controller is further configured to, during operation, change the residence time from a manufacturer-recommended value to reach a target moisture content provided by the manufacturer, based on the measured moisture content of the granular material.

11. The system of claim 10, wherein the controller is further configured to, during operation, change a temperature of the process air from a manufacturer-recommended value to reach the target moisture content provided by the manufacturer, based on the measured moisture content of the granular material.

12. The system of claim 1, wherein the controller is further configured to, during operation, regulate the residence time of the granular material within the drying hopper; and at least one of: the temperature of the process air; the humidity of the process air; and the flow rate of the process air, based on the measured moisture content of the granular material and a predetermined relationship between the moisture content of the granular material and at least one of the residence time of the granular material within the drying hopper; the temperature of the process air; the humidity of the process air; and the flow rate of the process air.

13. The system of claim 9, wherein the moisture sensor is mounted on the vacuum receiver or the vacuum loader.

14. The system of claim 1, wherein the granular material comprises one or more of resin granulates, a powdered material, and an agricultural grain.

15. The system of claim 1, further comprising at least one load cell mechanically coupled to the drying hopper and communicatively coupled to the controller, the at least one load cell being configured to generate an output relating to a combined weight of the drying hopper and the granular material residing within the drying hopper.

16. The system of claim 1, further comprising at least one level sensor mechanically coupled to the drying hopper and communicatively coupled to the controller, the at least one level sensor being configured to generate an output relating to a level of the granular material residing within the drying hopper.

17. The system of claim 4, wherein:
the vacuum source is a vacuum receiver; and
the system further comprises at least one load cell mechanically coupled to the vacuum receiver and communicatively coupled to the controller, the at least one load cell being configured to generate an output relating to a combined weight of the vacuum receiver and the granular material residing within the vacuum receiver.

18. A process for drying a granular material, comprising:
providing a storage vessel configured to hold the granular material;
providing a drying hopper comprising a body defining an interior volume configured to receive the granular material, and a diffuser configured to direct process air into the interior volume;
transferring the granular material from the storage vessel and to the drying hopper;
measuring a moisture content of the granular material upstream of the drying hopper; and
regulating a residence time of the granular material within the drying hopper and at least one of a temperature of the process air; a humidity of the process air; and a flow rate of the process air, based on the measured moisture content of the granular material.

19. The process of claim 18, wherein measuring the moisture content of the granular material upstream of the drying hopper comprises measuring the moisture content of the granular material at the storage vessel.

20. The process of claim 18, further comprising providing a vacuum source configured to transfer the granular material from the storage vessel and to the drying hopper.

21. The process of claim 20, further comprising:
providing a pickup wand in fluid communication with the vacuum source; and
immersing an end of the pickup wand in the granular material within the storge vessel.

22. The process of claim 21, further comprising:
providing a moisture sensor mounted on the pickup wand; and
measuring the moisture content of the granular material upstream of the drying hopper using the moisture sensor.

23. The process of claim 20, wherein the vacuum source is one of a vacuum receiver and a vacuum loader.

24. The process of claim 18, further comprising regulating at least one of: the residence time of the granular material within the drying hopper; the temperature of the process air; the humidity of the process air; and the flow rate of the process air, based on the measured moisture content of the granular material and a predetermined relationship between the moisture content of the granular material and at least one of the residence time of the granular material within the drying hopper; the temperature of the process air; the humidity of the process air; and the flow rate of the process air.

25. The process of claim 18, wherein the storage vessel is one of a Gaylord box, an octobin, a remote storage vessel, a railcar, and a silo.

26. The process of claim 18, further comprising:
providing a dry air generator in fluid communication with the drying hopper and configured to, during operation, remove moisture from the process air;
providing a heater in fluid communication with the drying hopper and the dry air generator, the heater being configured to, during operation, heat the process air; and
providing a blower in fluid communication with the drying hopper, the dry air generator, and the heater, the blower being configured to, during operation, circulate the process air between the drying hopper, the dry air generator, and the heater.

27. The process of claim 18, further comprising providing the granular material in the form of one or more of resin granulates, a powdered material, and agricultural grains.

28. The process of claim 18, further comprising changing the residence time from a manufacturer-recommended value to reach a target moisture content provided by the manufacturer, based on the measured moisture content of the granular material.

29. The process of claim 28, further comprising changing a temperature of the process air from a manufacturer-recommended value to reach the target moisture content provided by the manufacturer, based on the measured moisture content of the granular material.
